(19) United States
(12) Patent Application Publication
(10) Pub. No.: US 2013/0278551 A1
(43) Pub. Date: Oct. 24, 2013

(54) CAPACITIVE TOUCH SENSOR

(71) Applicants: Jin-Hyuk Kim, Gangnam-gu (KR); Jong-Sun Kim, Hwaseong-si (KR)

(72) Inventors: Jin-Hyuk Kim, Gangnam-gu (KR); Jong-Sun Kim, Hwaseong-si (KR)

(73) Assignee: SILICONINSIDE CO., LTD., Gyeonggi-do (KR)

(21) Appl. No.: 13/810,181

(22) PCT Filed: Jul. 15, 2010
(86) PCT No.: PCT/KR2010/004620

§ 371 Date: Mar. 27, 2013

(51) Int. Cl. G06F 3/044

(52) U.S. Cl. CPC G06F 3/044
USPC 345/174

(57) ABSTRACT

The present invention relates to a capacitive touch sensor, and relates to a touch sensor which precisely senses whether there is any touch, without using a reference voltage or reference current in the touch sensor but by converting data between neighboring channels into two types of data having different polarities and by comparing the same. The invention makes it possible to miniaturize a structure of the touch sensor and to ensure compatibility allowing application to a variety of touch panels by minimizing the influence of noise from the outside environment. More specifically, the present invention provides a capacitive touch sensor comprising: at least one receiver channel R_{X} which outputs analog data of a voltage for change in capacitance caused by presence or absence of a transmitter channel T_{X} pulse impression and touch; at least one receiver unit which is connected to the receiver channel R_{X}, receives the analog data of the voltage, and outputs bipolar pulse width modulation signals; a counter which periodically operates in accordance with reset RST signals; and at least one flip-flop which outputs, as digital data, the bipolar pulse width modulation signals input from the receiver unit, by using count values received from the counter.

### TECHNICAL FIELD

The present invention relates to a capacitive touch sensor, and more particularly to touch sensor which precisely senses whether there is any touch, not by using a reference voltage or reference current in the touch sensor but by converting data between neighboring channels into two types of data having different polarities and by comparing the same. According to the invention, it is possible to miniaturize a structure of the touch sensor and to ensure compatibility applicable to a variety of touch panels by minimizing the influence of noise from the outside environment.

### BACKGROUND ART

A touch sensor may be mainly classified into a resistive film type and a capacitive type. The capacitive touch sensor refers to a sensor which detects the change in capacitance created between a detection plate and an approach object when an object approaches a sense electrode or makes contact with the sensing electrode, and determines contact presence according to the detection result. That is, the capacitive touch sensor detects a difference between a preset value and a minute change value in capacitance formed between the object and the sense electrode when a human body makes contact with the sense electrode to generate a final output signal.

According to the related art, the change in capacitance is generally measured by detecting an oscillating frequency or a change amount of charging/discharging time. That is, if the object makes contact with the sense electrode of the capacitive touch sensor, the change in capacitance occurs between the object and the sense electrode. An oscillating frequency or the charging/discharging time of an oscillator is detected according to the change in the capacitance so that the presence of a contact is determined.

However, the scheme according to the related art may be affected by the change in the capacitance induced by the object making contact with the capacitive touch sensor and external noise which is suddenly applied.

Further, the scheme according to the related art may be influenced by external electric noise due to power. That is, since the capacitance is increased or reduced due to peripheral noise, although the capacitive touch sensor is not touched, touch output is generated. Even if the capacitive touch sensor is touched, the sensitivity thereof is lowered so that the touch output is not generated.

Accordingly, there is a need for touch sensor to minimize the influence with respect to power or the generation of external electric noise because a reference voltage/current is not used, and simply/miniaturize an operation of the touch sensor by simply implementing a noise filter therethrough.

### DISCLOSURE

### Technical Problem

The present invention has been made in view of the above problems, and provides a touch sensor capable of minimizing the influence of noise without using a reference voltage or reference current in the touch sensor and capable of performing sensing using data between neighboring channels.

The present invention further ensures two types of data having different polarities in analog to digital conversion using an up-reference voltage V_{UP} and a down-reference voltage V_{DN} which are actively changed rather than a fixed reference voltage and determines whether there is any touch using the two types of data having different polarities.

Objects of the present invention may not be limited to the above and other objects and which are not described may be clearly comprehended to those of skill in the art to which the embodiment pertains through the following description.

### Technical Solution

In order to achieve the objects as described above, there is provided a capacitive touch sensor including: at least one receiver channel RX which outputs analog data of a voltage for change in capacitance caused by presence or absence of a transmitter channel TX pulse impression and touch; at least one receiver unit which is connected to the receiver channel RX, receives the analog data of the voltage, and outputs bipolar pulse width modulation signals; a counter which periodically operates in accordance with reset RST signals; and at least one flip-flop which outputs, as digital data, the bipolar pulse width modulation signals input from the receiver unit, by using count values received from the counter.

The capacitive touch sensor may further include control logic units receiving and comparing digital data from neighboring flip-flops with each other to output only one digital data based on a most significant bit.

The counter may include an n-bit down counter determining an n+1 bit being a most significant bit (MSB) according to polarities of the bipolar PWM signals from the receiver unit.

The receiver unit may compare analog data of voltages generated from neighboring channels among the receiver channels with each other, and may modulate pulse widths of the respective analog data to output bipolar PWM signals.

The receiver unit may include: at least one sampling/holding signal impression unit connected to the receiver channels, respectively for impressing a sampling/hold signal to sample the analog data of the voltage; a charge transfer sensing receiving and comparing the sampled analog data output from neighboring sampling/holding signal impression unit with each other based on a charge amount to output analog data; a pulse width modulator receiving outputs of the charge transfer sensing and modulating a pulse signal width of the outputs of the charge transfer sensing to output the bipolar PWM signals.

The charge transfer sensing may include: a Gm-amplifier receiving and comparing output signals of the neighboring sampling/holding impression units with each other to generate an output voltage; a first capacitor connected to an output terminal of the Gm-amplifier to charge/discharge an electric charge; and an initial voltage impression terminal connected to an output terminal of the Gm-amplifier by on/off of a reset signal RST to impress an initial voltage.

The capacitive touch sensor pulse width modulator may include: a first comparator receiving an output voltage of a charge transfer system through a positive input terminal and an up-reference voltage through a negative input terminal to output a positive PWM signal among the bipolar PWM signals; and a second comparator receiving the output voltage of the charge transfer system through a positive input terminal and a down-reference voltage through a negative input terminal to output a negative PWM signal among the bipolar PWM signals.

Based on a reset signal applied to an output voltage terminal, the up-reference voltage may be reduced according to lapse of a time, and the down-reference voltage may be increased according to the lapse of the time.

The up-reference voltage and the down-reference voltage may be a same as each other within one period of the reset signal at least once according to an output of the counter.

A period of the positive PWM signal PWM_POS may be determined by a following equation:

$${T}_{PWP} = T - \frac{{C}_{L} ( {V}_{TOP} - {V}_{INT} )}{{G}_{m} ( {V}_{S} [ n + 1 ] - {V}_{S} [ n ] ) - C \frac{{V}_{INT} - {V}_{TOP}}{T}}$$

where, the T is a period of the reset signal, the CL is capacitance of a first capacitor, the VTOP is a maximum value of the up-reference voltage VUP, the VINT is an initial voltage, the Gm is mutual conductance, the VS [n+1] and VS [n] are output voltages of neighboring sampling/holding signal impression units.

A period of the negative PWM signal PWM_NEG may be determined by a following equation:

$${T}_{PWN} = T - \frac{{C}_{L} ( {V}_{INT} - {V}_{BOT} )}{{G}_{m} ( {V}_{S} [ n + 1 ] - {V}_{S} [ n ] ) - C \frac{{V}_{BOT} - {V}_{INT}}{T}}$$

where, the T is the period of the reset signal, the C_{L} is the capacitance of the first capacitor, the V_{BOT} is a minimum value of the down-reference voltage V_{DN}, the V_{INT} is the initial voltage, the Gₘ is mutual conductance, the V_{S} [n+1] and V_{S} [n] are the output voltages of the neighboring sampling/holding signal impression units.

The digital data output from the control logic unit are converted by calibration and normalization using a following equation:

$${D}_{NORM ( m - BIT )} = {( \frac{\frac{{2}^{y}}{{2}^{y} - \vert {D}_{IN} \vert} {D}_{IN}}{{2}^{x}} )}_{( ( 2 x \times y ) - x ) - BIT} - {( \frac{\frac{{2}^{y}}{{2}^{y} - \vert {D}_{CAL} \vert} {D}_{CAL}}{{2}^{x}} )}_{( ( 2 x \times y ) - x ) - BIT}$$

where, the D_{NORM(m-BIT)} is digital data normalized with an m bit, the D_{CAL} is a value acquiring initial data when there is no touch, and the D_{IN} is data according to the presence or absence of the touch in an actual operation, the m=(2·y)−x, the m, the x, and the y are a predetermined bit.

A sum of converted digital data from a first channel to the n-th channel by the calibration and the normalization may be used as final data for determining the presence of the touch, and the sum of the converted digital data satisfies following equations:

$$D ( n ) = {\sum }_{1}^{n} {D}_{NORM} ( n - 1 )$$

$$here {D}_{NORM} ( 0 ) = 0$$

where, the D(n) is data of the n-th channel and the D_{NORM}(n) is normalized data of the n-th channel.

### Advantageous Effects

Since the present invention generates and uses bipolar pulse width modulating signals using an up-reference voltage V_{UP} and a down-reference voltage V_{DN} which are actively changed, the present invention can ensure a difference between channels having polarity in analog to digital conversion of the touch sensor. Since the determination whether there is any touch integrates the difference between the channels and the integrated difference is used as final data, it is not necessary to generate the internal reference current/voltage.

That is, since the present invention can perform sensing using data between neighboring channels without generation of the reference voltage/current in the touch sensor, the influence of noise from the outside environment can be minimized.

Accordingly, the use of firmware for noise filtering of the touch sensor can be simplified, the size of a memory can be reduced, and an area occupied by a micro-processor unit (MPU) can be minimized. The compatibility easily applicable to various types of touch panels can be ensured.

In addition, since touch sensor driving circuit of the present invention has a relative simple structure, the sampling speed of an analog signal can be rapidly adjusted.

### DESCRIPTION OF DRAWINGS

FIGS. 1 and 2 are a configuration diagram and a circuitry diagram of a touch panel to which a capacitive touch sensor according to an embodiment of the present invention is applied, respectively.

FIGS. 3 and 4 are exemplary diagrams illustrating the change in capacitance according to the presence of touch on the touch panel to which a capacitive touch sensor according to an embodiment of the present invention is applied.

FIG. 5 is an exemplary diagram illustrating a capacitive touch sensor according to the related art.

FIG. 6 is an exemplary diagram illustrating touch determination of a capacitive touch sensor according to the related art.

FIG. 7 is a diagram illustrating a configuration of a capacitive touch sensor according to the embodiment of the present invention.

FIGS. 8 to 11 are exemplary diagrams illustrating touch determination by a capacitive touch sensor according to the embodiment of the present invention.

FIG. 12 is a diagram illustrating a configuration of a receiver unit according to the embodiment of the present invention.

FIGS. 13 and 14 are timing diagrams of various data generated by a receiver unit according to the embodiment of the present invention.

FIG. 15 is a timing diagram of various data generated by the capacitive touch sensor according to the embodiment of the present invention.

FIG. 16 is an exemplary diagram of data obtained by calibrating and normalizing initial data of the capacitive touch sensor according to the embodiment of the present invention.

FIGS. 17 and 18 are exemplary diagrams illustrating variation of data according to normalization of initial data capacitive touch sensor according to the embodiment of the present invention.

### BEST MODE

### Mode of the Invention

Hereinafter, exemplary embodiments of the present invention are described with reference to the accompanying drawings in detail. Terms and words used in the specification and the claims shall not be interpreted as commonly-used dictionary meanings, but shall be interpreted as to be relevant to the technical scope of the invention based on the fact that the inventor may property define the concept of the terms to explain the invention in best ways. Therefore, the embodiments and the configurations depicted in the drawings are illustrative purposes only and do not represent all technical scopes of the embodiments, so it should be understood that various equivalents and modifications may exist at the time of filing this application.

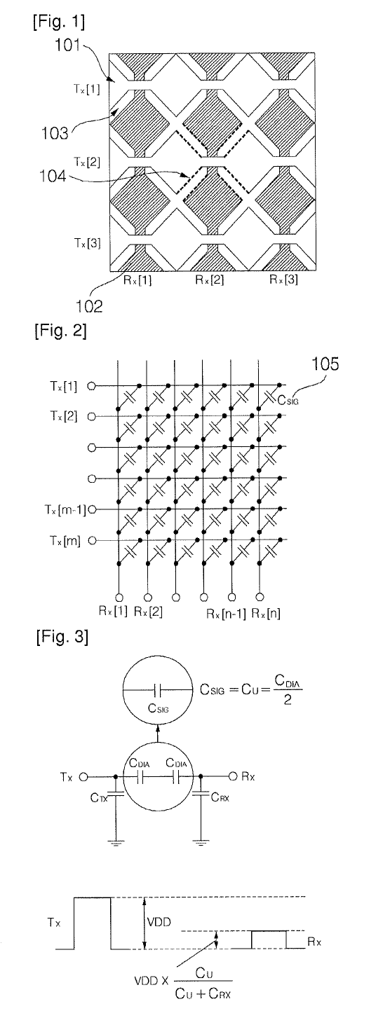

FIGS. 1 and 2 are a configuration diagram and a circuitry diagram illustrating touch panel to which a capacitive touch sensor according to an embodiment of the present invention is applied, respectively.

FIG. 1 is an exemplary diagram illustrating upper/lower patterns of a touch panel to which the capacitive touch panel according to the embodiment of the present invention is applied.

FIG. 1 illustrates upper/lower surface of a lattice touch panel, which may include two capacitive sensing layers separated from each other by an insulating material. Each of the two capacitive sensing layers includes substantially parallel conducting elements, and the conductive elements of the two sensing layers are substantially orthogonal to each other. The two capacitive sensing layers are formed while interposing an insulating material therebetween to represent a capacitive effect.

In the present invention, the capacitive sensing layer may include a transmitter channel T_{X} impressing a predetermined pulse to a panel and a receiver channel R_{X} sensing and outputting the change in capacitance. It is preferable that the transmitter channel T_{X} and the receiver channel R_{X} are configured in an array pattern.

In the present invention, in order to detect a location in which touch or push occurs, the capacitive sensing layer may be used by sequentially inputting a predetermined pulse to a transmitter channel T_{X} axis, and sensing a voltage level of a receiver channel R_{X} axis to calculate and determine touched location.

The conducting element may be configured by a series of diamond shaped patterns 104 connected to each other through narrow conductive rectangular stripes. The conducting element is not limited to the diamond shaped pattern, but may have various shapes as necessary in the present invention.

One end or both ends of each conducting element of the sensing layer may be electrically connected to a lead line of a corresponding lead line set.

FIG. 2 is a circuitry diagram corresponding to a configuration of the touch panel shown in FIG. 1.

The transmitter channels T_{X} and the receiver channels R_{X} are formed while interposing an insulating material therebetween, respectively. The capacitive effect is generated between a diamond pattern of the transmitter channel T_{X} and a diamond pattern of the receiver channel R_{X} so that capacitance C_{SIG} 105 is created. That is, capacitance may be created between an upper substrate 101 and a lower substrate 102.

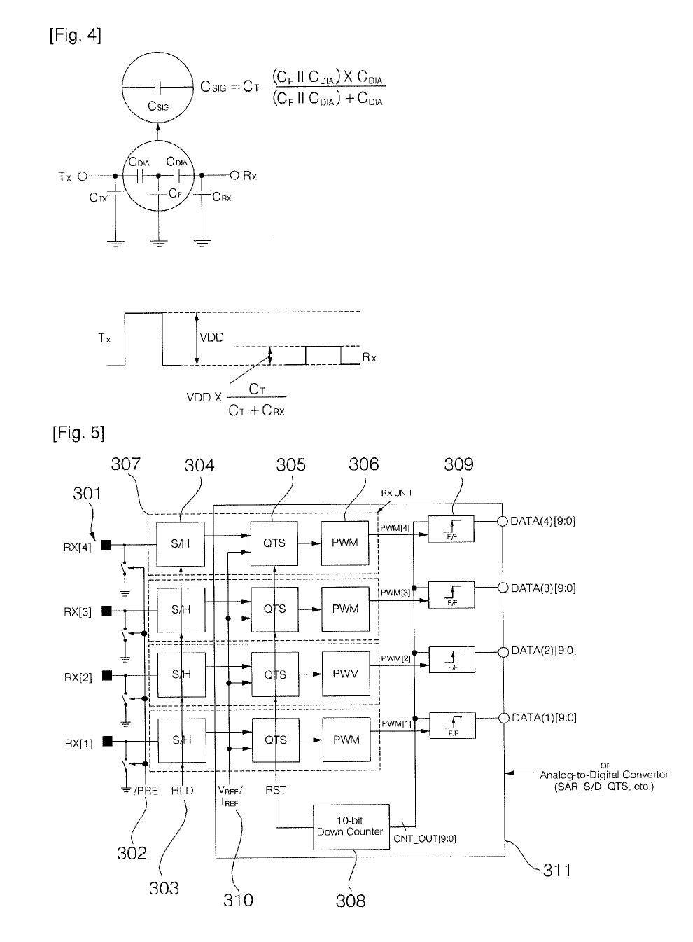

FIGS. 3 and 4 are exemplary diagrams illustrating the change in capacitance according to the presence of touch on the touch panel to which a capacitive touch sensor according to an embodiment of the present invention is applied.

FIG. 3 is an exemplary diagram illustrating the change in capacitance and input/output response when there is no touch.

FIG. 3 illustrates capacitances created between the transmitter channel T_{X} and the receiver channel R_{X}. Here, C_{TX} is capacitance of the transmitter channel T_{X}, C_{RX} is capacitance of the receiver channel R_{X}, and C_{DIA} is capacitance of the diamond pattern.

When there is no touch on the touch panel, the capacitance C_{SIG} 105 created between the diamond patterns may be expressed by a following equation 1.

$${C}_{SIG} = {C}_{U} = \frac{{C}_{DIA}}{2} \qquad Equation 1$$

Since capacitance C_{DIA} of the diamond pattern of the transmitter channel T_{X} is serially connected to capacitance C_{DIA} of a diamond pattern of the receiver channel R_{X}, a result as expressed in the following 1 is obtained.

In order to sense the change in the capacitance, a predetermined pulse is applied to the transmitter channel T_{X}. In the present invention, amplitude of the pulse refers to V_{DD}. In a case where there is no touch and a pulse having amplitude of V_{DD} is input, amplitude APL_{RX}_{_{—}}_{U} of a sensing signal output from the receiver channel R_{X} may be expressed by a following equation 2.

$${APL}_{RX\_U} = {V}_{DD} \times \frac{{C}_{U}}{{C}_{U} + {C}_{RX}} \qquad Equation 2$$

Here, referring to the equation 1,

$${C}_{U} = \frac{{C}_{DIA}}{2} .$$

FIG. 4 is an exemplary diagram illustrating the change in the capacitance and input/output response when there is touch.

FIG. 4 illustrates capacitances created between the transmitter channel T_{X} and the receiver channel R_{X} when there is the touch. Here, C_{TX} is capacitance of the transmitter channel T_{X}, C_{RX} is capacitance of the receiver channel R_{X}, and C_{DIA} is capacitance of the diamond pattern. Finger capacitance C_{F} due to the touch may be added between capacitances of diamond patterns of the upper substrate and the lower substrate.

Accordingly, the capacitance C_{SIG} created between the diamond patterns may be expressed by a following equation 3 when there is the touch on the touch panel.

$${C}_{SIG} = {C}_{T} = \frac{( CF \vert \vert {C}_{DIA} ) \cdot {C}_{DIA}}{( CF \vert \vert {C}_{DIA} ) + {C}_{DIA}} \qquad Equation 3$$

Further, in a case where there is the touch, if the pulse having amplitude of the V_{DD} is input to the transmitter channel T_{X}, amplitude APL_{RX}_{_{—}}_{T} of a sensing signal output from the receiver channel R_{X} may be expressed by a following equation 4.

$${APL}_{RX\_T} = {V}_{DD} \times \frac{{C}_{T}}{{C}_{T} \times {C}_{RX}} \qquad Equation 4$$

Here, referring to the equation 3, it is satisfied that

$${C}_{T} = \frac{( CF \vert \vert {C}_{DIA} ) \cdot {C}_{DIA`}}{( CF \vert \vert {C}_{DIA} ) + {C}_{DIA}} .$$

Here, comparison of a case where there is the touch with a case where there is no touch may be expressed by a following equation 5.

$${V}_{DD} \times \frac{{C}_{U}}{{C}_{U} + {C}_{RX}} > {V}_{DD} \times \frac{{C}_{T}}{{C}_{T} + {C}_{RX}} , ∵ {C}_{U} > {C}_{T} \qquad Equation 5$$

That is, the magnitude of a sensing signal where there is no touch may be greater than that where there is the touch. This may be because addition of the finger capacitance C_{F} influences on charge share of the C_{U} and the C_{RX}.

The sensing signal is input now to the sensing circuit through the receiver channel R_{X}. This will be described below.

FIG. 5 is an exemplary diagram illustrating a capacitive touch sensor according to the related art.

According to the related art, analog data corresponding to the change in the capacitance input through the receiver channel R_{X} 301 is sampled by a sampling/holding signal impression unit 304 and the sampled data are output to a charge transfer sensing (QTS) 305.

The QTS 305 compares input analog data with a reference voltage 310 (or reference current) to generate an output voltage, and transfers the output voltage to a pulse width modulator 306 so that the pulse width modulator 305 modulates a width of a pulse signal and transfers the modulated pulse signal to a flip-flop 309.

The flip-flop 309 receives a predetermined counter value generated from a counter 308, and synchronizes the received predetermined counter value with a clock pulse signal to output an output value of the QTS being an input value as digital data.

That is, the flip-flop 309 outputs the reference voltage 310 or a reference current 310 to the QTS 305 as a reference value to be compared with sampled analog data. If external power is applied to the QTS 305, precise touch sensing is difficult due to the occurrence of noise such as electric noise from the outside environment, and it is difficult to fabricate a touch sensor having a small size in form of a single thin film.

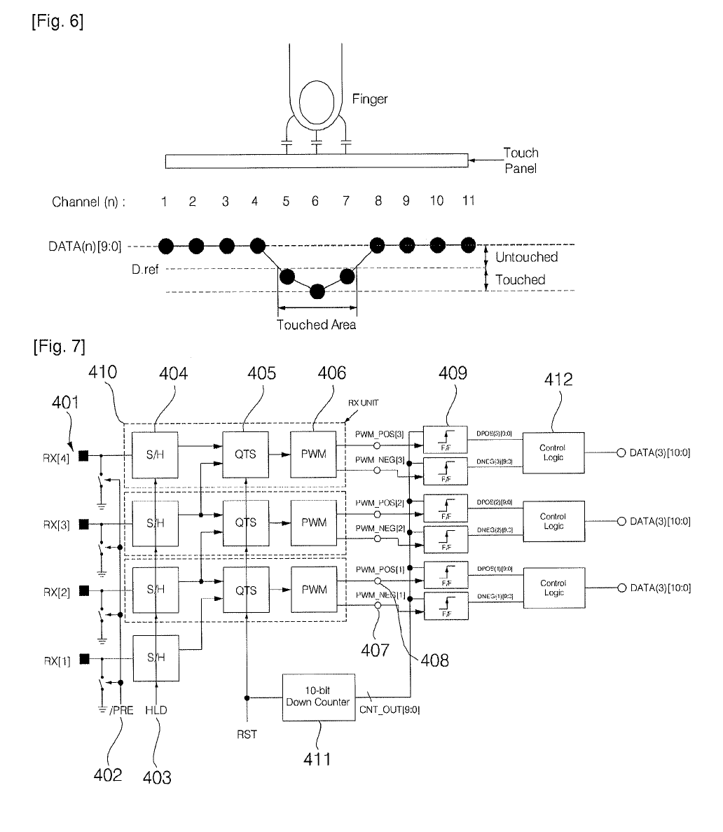

FIG. 6 is an exemplary diagram illustrating touch determination of a capacitive touch sensor according to the related art.

According to the related art, the capacitive touch sensor compares sampled data with a reference voltage or a reference current having a fixed value to determine whether there is touch.

That is, a reference value D.ref is fixed. If the touch occurs, when capacitance measured due to addition of the finger capacitance C_{F} is less than the reference value D.ref, the touch sensor determines that there is the touch.

In this case, since the reference value D.ref is fixed and C_{RX}/C_{TX} is variously changed according to design of the touch panel, the reference value D.ref must be varied according to the design of the touch panel.

FIG. 7 is a diagram illustrating a configuration of a capacitive touch sensor according to the embodiment of the present invention.

The capacitive touch sensor according to the embodiment of the present invention may include receiver channels R_{X} 401, a receiver unit 410, a counter 411, flip-flops 409, and control logic units 412. It is preferable that the receiver channel R_{X} 401, the receiver unit 410, the counter 411, the flip-flops 409, and the control logic units 412 may be configured in an array pattern.

The receiver channels R_{X} 401 output analog data of a voltage for change in capacitance caused by the presence or absence of a transmitter channel T_{X} pulse impression and touch. That is, the receiver channel R_{X} 401 is connected to a touch panel and transmits a sensing signal to the receiver unit 410 according to the presence or absence of the touch.

The receiver unit 410 compares analog data of voltages generated from neighboring channels among a plurality of receiver channels R_{X} with each other, and modulates pulse widths of the respective analog data to output bipolar PWM signals.

The receiver unit 410 may include sampling/holding signal impression units 404, a QTS 405, and a pulse width modulator 406.

The sampling/holding signal impression units 404 are connected to the receiver channels 401, respectively, and impress a sampling/hold signal to sample the analog data of the voltage.

Further, the QTSs 405 receive and compare the sampled analog data output from neighboring sampling/holding signal impression unit with each other to output comparison results.

The pulse width modulator 406 receives an output of the QTS 405 and modulates a pulse signal width of the output of the QTS 405 to output the bipolar PWM signal.

That is, collectively, the receiver unit 410 compares analog data of voltages generated from neighboring channels among a plurality of receiver channels R_{X} with each other, and outputs the comparison value as the bipolar PWM signals.

The counter 411 converts pulse widths of the bipolar PWM signals into digital data. It is preferable that the present invention adopts an n-bit down counter for determining an n+1 bit being a most significant bit (MSB) according to polarities of the bipolar PWM signals from the receiver unit 410, and converting pulse widths of the bipolar PWM signals into a digital signal as the counter.

The present invention is not limited to the n-bit down counter. A different type of counter may be used as necessary.

The flip-flops 409 outputs, as digital data, the bipolar PWM signals input from the receiver unit 410, by using count values received from the counter 411.

The control logic units 412 receives and compares digital data from neighboring flip-flops 409 with each other, and outputs only one digital data based on the MSB.

An operation of the control logic units 412 is as follows.

DATA[10]=0, DATA[9:0]=DPOS[9:0] (if DPOS[9:0]>DNEG [9:0])

DATA[10]=, DATA[9:0]=DNEG[9:0](if DPOS[9:0]>DNEG [9:0])

That is, the control logic units 412 receives 10-bit data representing different polarities from the flip-flops 409. When DPOS[9:0] representing a positive polarity is greater than DNEG[9:0] representing a negative polarity, final output data DATA[9:0] has DPOS[9:0], and DATA[10] being the MSB is set to “0”. On the contrary, when the DPOS[9:0] is less than the DNEG[9:0], the DATA[9:0] has DNEG[9:0], and the DATA[10] is set to “1”.

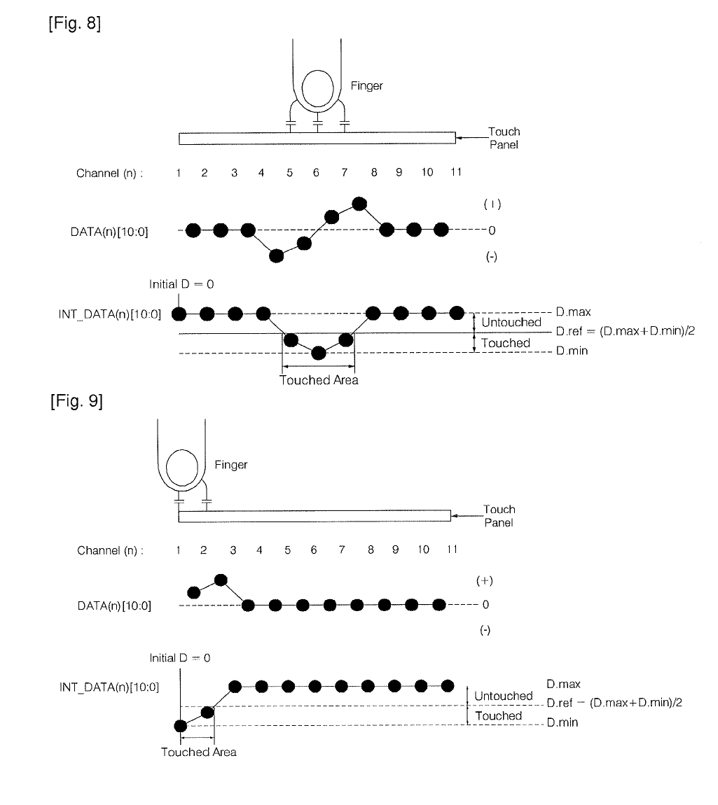

FIGS. 8 to 11 are exemplary diagrams illustrating touch determination by a capacitive touch sensor according to the embodiment of the present invention.

Referring to FIG. 8, if the capacitive touch sensor is touched using a finger of a human body, capacitance in a touched area is changed. In this case, digital data output from the control logic units 412 included in the touch sensor according to the present invention represents DATA(n) [10:0].

That is, since the present invention outputs comparison data between neighboring channels, initial data of a differential value is output as illustrated in the DATA(n) [10:0].

Integral values of data by channels are used as final data of touch determination.

That is, initial data illustrated in the DATA(n) [10:0] may be integrated and the integrated data may be output as INT_DATA(n) [10:0]. Accordingly, since the present invention uses an integrated value of comparison data between the neighboring channels as final data of the touch determination, rapid and precise sensing is possible without using a reference current or a reference voltage.

D._{MAX} and D._{MIN} illustrated in the INT_DATA (n) [10:0] may be flexibly varied, and a reference value D.ref becomes half of a sum of the D._{MAX} and the D._{MIN}.

FIG. 9 illustrates an output aspect of data when one edge part of the touch panel is touched by a finger of the human body.

In general, presence or absence of touch is determined in a state that initial data is set to 0 (initial D=0). As described above, since an initial value is not substantially “0” when one edge part is touched, a problem may occur in the present invention. That is, since the present invention uses a differential value of comparison data between the neighboring channels, that is, the initial data, the initial value may not be “0”. However, as described above, since the D._{MAX} and the D._{MIN} may be flexibly changed, and the reference value D.ref is half of a sum of the D._{MAX} and the D._{MIN} and is used for determination, the foregoing problem may be solved.

That is, as illustrated in the INT_DATA(n) [10:0], since profiles of integrated data of respective channels are relatively compared with each other, even if the initial value is always set to “0”, the touch determination may be performed.

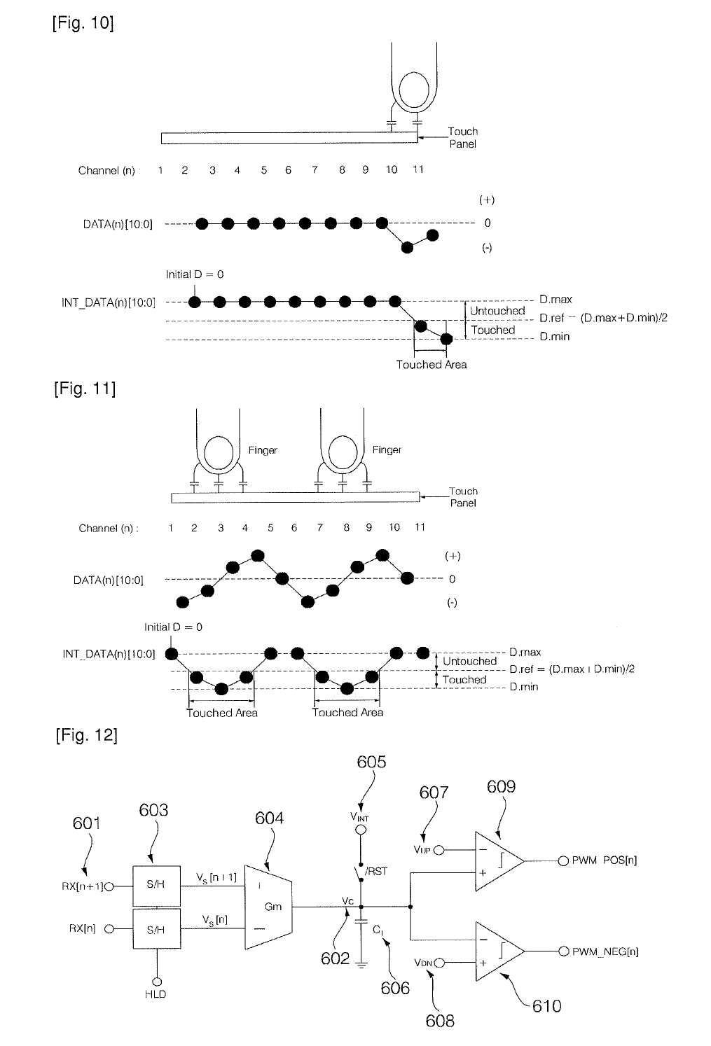

A variation aspect of data illustrated in FIG. 10 is similar to a part illustrated in FIG. 9, and thus a detailed description is omitted.

FIG. 11 illustrates an output aspect of data when multi-touch occurs.

That is, the present invention may easily determine the presence of touch with respect to all types of multi-touches. The present invention may acquire initial data illustrated in DATA(n)[10:0] which is the change in the capacitance on the touch panel. The present invention may integrate initial data illustrated in the DATA(n) [10:0] to finally acquire data illustrated in the INT_DATA(n) [10:0].

As described above, since the present invention forms a reference value using a reference voltage which is actively varied, the touch determination is easy.

FIG. 12 is a diagram illustrating a configuration of a receiver unit according to the embodiment of the present invention.

As described above, the receiver unit may include the sampling/holding impression units 603, the QTS and the PULSE WIDTH MODULATOR.

If a sensing signal from a receiver channel R_{X} 601 is sampled through the sampling/holding impression units 603, the sampled sensing signal is output as voltage data by channels. That is, the output signals of the sampling/holding impression unit 603 are illustrated as V_{S} [n+1] and V_{S} [n] in FIG. 12.

The QTS may include a Gm-amplifier 604 receiving and comparing output signals of the neighboring sampling/holding impression units 603 with each other to generate an output voltage V_{C}; a first capacitor C_{L} 606 connected to an output terminal of the Gm-amplifier 604 to charge/discharge an electric charge; and an initial voltage V_{INT} impression terminal 605 connected to the output terminal of the Gm-amplifier 604 by on/off of a reset signal RST to impress an initial voltage V_{INT}.

Output signals V_{S} [n+1] and V_{S} [n] of the sampling/holding signal impression units 603 are provided to the Gm-amplifier 604 so that an output voltage V_{C} 602 is generated. The Gm-amplifier 604 amplifies a voltage difference of the output signals of the sampling/holding signal impression units 603 as a current, and outputs the amplified current.

In this case, after the impression of the initial voltage V_{INT} and the reset signal, charged/discharged charge amount is changed according to V_{S} [n+1] and V_{S} [n]. In this case, according to the output voltage V_{C}, the PULSE WIDTH MODULATOR classifies and outputs polarities of the pulse width signals.

The PULSE WIDTH MODULATOR may include an up-reference voltage V_{UP} impression terminal, a down-reference voltage V_{DN} impression terminal, a first comparator 609, and a second comparator 610.

The first comparator 609 receives the output voltage V_{C} of the QTS 405 through a positive input terminal and an up-reference voltage V_{UP} 607 through a negative input to output a positive PWM signal PWM_POS among the bipolar PWM signals.

The second comparator 610 receives the output voltage V_{C} of the QTS 405 through a positive input terminal and a down-reference voltage V_{DN} 608 through a negative input terminal to output a negative PWM signal PWM_NEG among the bipolar PWM signals.

The positive PWM signal PWM_POS and the negative PWM signal PWM_NEG are transferred to the flip-flops 409 so the flip-flops 409 modulate the positive PWM signal PWM_POS and the negative PWM signal PWM_NEG to digital data using a predetermined counter value, and transfers the digital data to the control logic units 412.

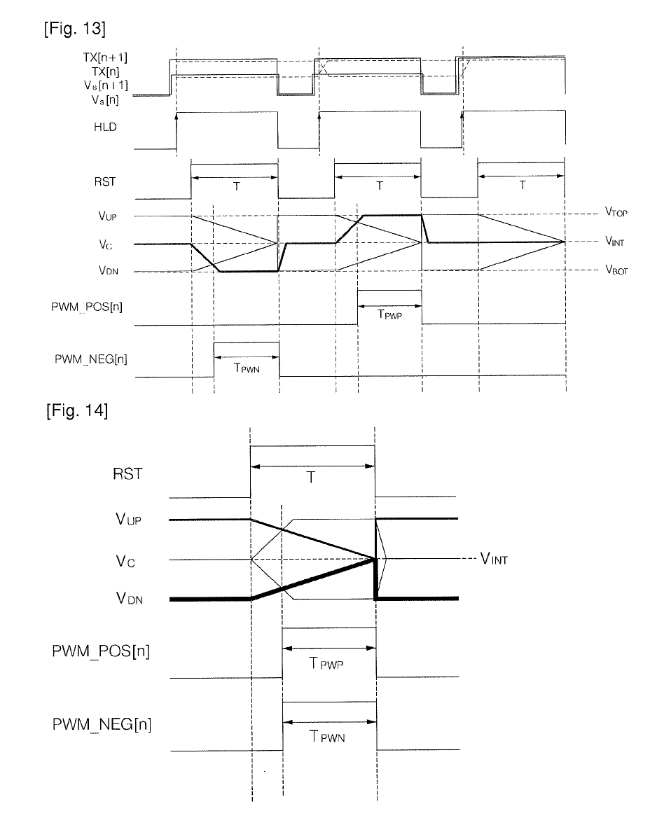

FIGS. 13 and 14 are timing diagrams of various data generated by a receiver unit according to the embodiment of the present invention.

FIG. 13 illustrates variation aspects of various signals and data by the configuration diagram shown in FIG. 12.

A holding signal is impressed to the sampling/holding signal impression unit and a reset signal RST having a period T is impressed to the sampling/holding signal impression unit at a predetermined time interval.

Analog data of a voltage from the receiver channel R_{X} is sampled through the sampling/holding signal impression unit, and the sampled data is output to the Gm-amplifier 604 so that an output voltage V_{C} is generated. Presence of impression of the initial voltage V_{INT} is determined according to presence of impression of the reset signal RST.

In this case, a difference of a charge amount charged/discharged in the first capacitor C_{L} 606 is represented as an output voltage V_{C} according to input signals V_{S} [n+1] and V_{S} [n] of the Gm-amplifier 604. Bipolar PWM signals having different polarities may be output based on the difference of the charge amount.

In the PWM, the output voltage V_{C} of the Gm-amplifier 604 is input to the positive input terminal of the first comparator 609, and the up-reference voltage V_{UP} is input to the negative input terminal of the first comparator 609. The down-reference voltage V_{DN} is input to the positive input terminal of the second comparator 610, and the output voltage V_{C} of the Gm-amplifier 604 is input to the negative input terminal of the second comparator 610.

The up-reference voltage V_{UP} and the down-reference voltage V_{DN} are flexibly varied according to times. It is preferable that the up-reference voltage V_{UP} is reduced according to lapse of a time, and the down-reference voltage V_{DN} is increased according to the lapse of the time.

It is preferable that the up-reference voltage V_{UP} and the down-reference voltage V_{DN} are the same as each other within one period of the reset signal RST at least once according to times, that is, according to an output of the counter.

Referring to FIG. 13, when the output voltage V_{C} of the Gm-amplifier 604 meets the up-reference voltage V_{UP}, the positive PWM signal PWM_POS is output. When the output voltage V_{C} of the Gm-amplifier 604 meets the down-reference voltage V_{DN}, the negative PWM signal PWM_NEG is output.

A point where the up-reference voltage V_{UP} and the down-reference voltage V_{DN} are the same as each other within one period of the reset signal RST at least once may be the initial voltage V_{INT}.

FIG. 14 illustrates a variation amount of various data in one period of the reset signal RST.

In the present invention, a period of the positive PWM signal PWM_POS is determined by a following equation 6.

$${T}_{PWP} = T - \frac{{C}_{L} ( {V}_{TOP} - {V}_{INT} )}{{G}_{m} ( {V}_{S} [ n + 1 ] - {V}_{S} [ n ] ) - C \frac{{V}_{INT} - {V}_{TOP}}{T}} \qquad Equation 6$$

Here, T is a period of the reset signal RST, C_{L} is capacitance of the first capacitor 606, V_{TOP} is a maximum value of the up-reference voltage V_{UP}, V_{INT} is an initial voltage, Gₘ is mutual conductance, V_{S} [n+1] and V_{S} [n] are output voltages of neighboring sampling/holding signal impression units.

A period of the negative PWM signal PWM_NEG is determined by a following equation 7.

$${T}_{PWN} = T - \frac{{C}_{L} ( {V}_{INT} - {V}_{BOT} )}{{G}_{m} ( {V}_{S} [ n ] - {V}_{S} [ n + 1 ] ) - C \frac{{V}_{BOT} - {V}_{INT}}{T}} \qquad Equation 7$$

Here, T is a period of the reset signal RST, C_{L} is capacitance of the first capacitor 606, V_{BOT} is a minimum value of the down-reference voltage V_{DN}, V_{INT} is an initial voltage, Gₘ is mutual conductance, V_{S} [n+1] and V_{S} [n] are output voltages of neighboring sampling/holding signal impression units.

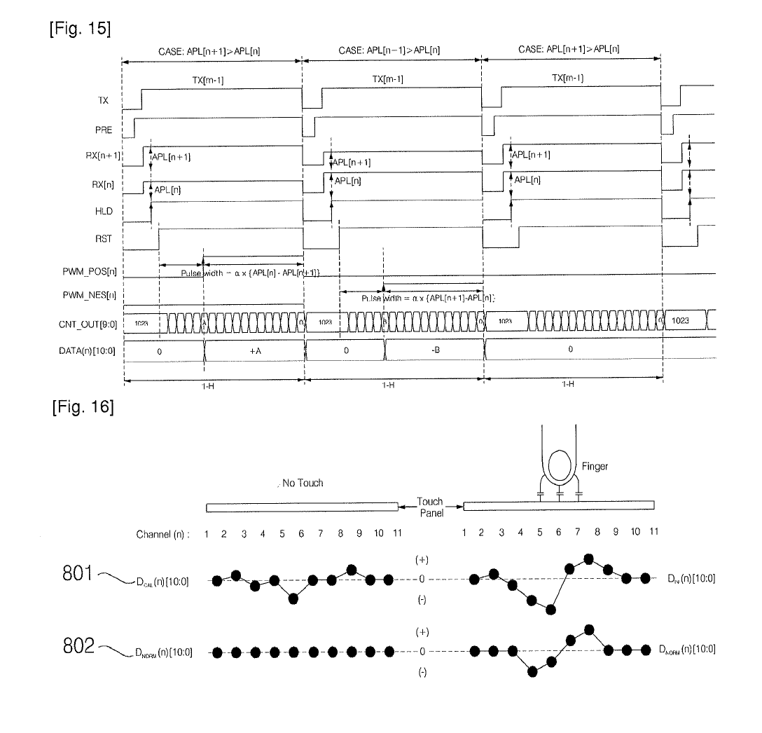

FIG. 15 is a timing diagram of various data generated by the capacitive touch sensor according to the embodiment of the present invention.

First, during a period when a precharge signal PRE is low, both of the transmitter channel T_{X} and the receiver channel R_{X} are charged with a ground. When a predetermined time elapses after the precharge signal PRE becomes high, the receiver channel R_{X} outputs analog data of a voltage according to the change in capacitance.

Next, a holding signal HLD is applied to an output terminal of the receiver channel R_{X}, the analog data of the voltage are sampled, and then the reset signal RST is applied to the counter 411. If the reset signal RST is applied to the counter 411, the counter 411 operates to supply a predetermined count value to a flip-flop 409.

As described above, the control logic unit compares response magnitudes of output signals from the neighboring receiver channels R_{X} with each other to finally output one among bipolar PWM signals. That is, the control logic unit compares response magnitudes of output signals from the neighboring receiver channels R_{X} with each other to determine the positive PWM signal PWM_POS and the negative PWM signal PWM_NEG.

As shown in FIG. 15, if response magnitude of an output signal of a neighboring receiver channel, that is, magnitude of a response signal of an R_{X} [n+1] channel is greater than that of an R_{X}[n] channel, the positive PWM signal PWM_POS is output. In this case, a pulse width of a PWM_POS [n] indicates α·(APL [n]-APL [n+1]).

Moreover, magnitude of a response signal of an R_{X} [n] channel is greater than that of an R_{X} [n+1] channel, the negative PWM signal PWM_NEG is output. In this case, a pulse width of a PWM_NEG indicates α·(APL [n+1]-APL [n]).

Data determining the presence of touch are generated by adding a count value from the counter 411 according to the positive PWM signal PWM_POS or the negative PWM signal PWM_NEG. That is, initial data DATA(n)[10:0] are output. According to an arithmetic result of the control logic unit 412, data having a (+) polarity or a (−) polarity are output.

In the present invention, the initial data DATA(n)[10:0] are finally integrated to INT_DATA(n)[10:0], and the presence of the touch is determined using the INT_DATA(n)[10:0].

FIG. 16 is an exemplary diagram of data obtained by calibrating and normalizing initial data of the capacitive touch sensor according to the embodiment of the present invention.

In a case of an ideal touch panel, initial data are represented as illustrated in 802, but it is difficult to acquire ideal data due to the outside environment of a touch panel such as defects or scattering of the touch panel.

The presence of the touch may be precisely determined by performing a calibration operation acquiring initial data of the touch panel when there is no touch operation, and normalizing the initial data according to the presence or absence of the touch in an actual operation to generate ideal data.

In the present invention, digital data output from the control logic unit 412 are converted by calibration and normalization using a following equation 8.

$${D}_{NORM ( m - BIT )} = {( \frac{\frac{{2}^{y}}{{2}^{y} - \vert {D}_{IN} \vert} {D}_{IN}}{{2}^{x}} )}_{( ( 2 x > y ) - x ) - BIT} - {( \frac{\frac{{2}^{y}}{{2}^{y} - \vert {D}_{CAL} \vert} {D}_{CAL}}{{2}^{x}} )}_{( ( 2 x \times y ) - x ) - BIT} \qquad Equation 8$$

Here, D_{NORM(m-BIT)} is digital data normalized with an m bit, D_{CAL} is a value acquiring initial data when there is no touch, and D_{IN} is data according to the presence or absence of the touch in an actual operation. Here, m=(2·y)−x. The m, x, and y are a predetermined bit.

The present invention generates final data using the D_{NORM(m-BIT)}, and finally determines whether there is any touch. That is, the present invention determines whether there is any touch using a sum of digital data from a first channel to an n-th channel which are converted by normalization.

The sum of the digital data satisfies a following equation.

$$D ( n ) = {\sum }_{1}^{n} {D}_{NORM} ( n - 1 ) \\ here {D}_{NORM} ( 0 ) = 0 \qquad Equation 9$$

Here, D(n) is data of the n-th channel, and D_{NORM}(n) is normalized data of the n-th channel.

That is, the final data are a value obtained by integrating initial data by an n-th channel, which may be the same as the sum of converted digital data from a first channel to the n-th channel by the normalization.

Different from the related art, the present invention acquires the difference between channels and integrates the acquired difference between channels to determine whether there is any touch. That is, the present invention determines whether there is any touch using comparison data between neighboring channels without using a reference voltage and/or a reference current.

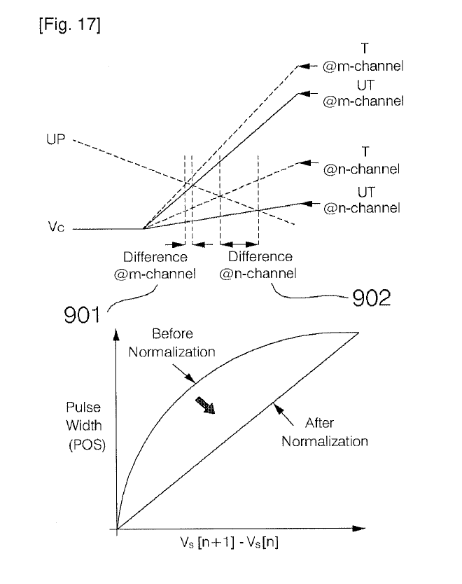

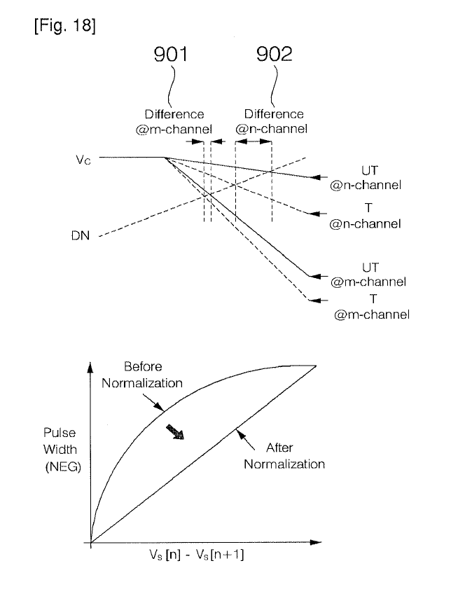

FIGS. 17 and 18 are exemplary diagrams illustrating variation of data according to normalization of initial data capacitive touch sensor according to the embodiment of the present invention.

FIG. 17 illustrates output voltages V_{C} by channels which are varied according to the presence of scattering of a panel. A slope of the output voltage V_{C} is linearly according to the presence or absence of the touch by respective channels, but time variation is non-linearly indicated according to the presence or absence of the touch due to initial state in an untouched state.

In the same manner, referring to FIG. 18, the slope of the output voltage V_{C} is linearly according to the presence or absence of the touch by respective channels, but time variation is non-linearly indicated according to the presence or absence of the touch due to initial state in an untouched state.

Accordingly, as illustrated in bottom graphs of FIGS. 17 and 18, the precision of touch determination can be improved by performing a normalization operation so that a pulse width of the positive PWM signal having a curved shape is corrected to a straight line.

Although embodiments have been described with reference to a number of illustrative embodiments thereof, it should be understood that numerous other modifications and embodiments can be devised by those skilled in the art that will fall within the spirit and scope of the principles of this disclosure, and variations and modifications can be made to the disclosure without departing from the technical spirit and equivalent scopes of the appended claims of the present invention.

### DESCRIPTION OF REFERENCE NUMERALS

101: upper substrate
102: lower substrate
103: ITO pattern
104: diamond pattern
105: capacitance of diamond pattern
301,401,601: receiver channel
302,402: precharge signal
303,403: holding signal
304,404,603: sampling/holding signal impression unit
305,405: QTS
306,406: PWM
307,410: receiver unit
308,411: counter
309,409: flip-flop
310: reference voltage/current
311: analog/digital converter
407: negative PWM signal PWM_NEG output terminal
408: positive PWM signal PWM_POS output terminal
412: control logic unit
602: output voltage V_{C} terminal
604: Gm amplifier
605: initial voltage V_{INT} terminal
606: first capacitor C_{L}
607: up-reference voltage V_{UP}
608: down-reference voltage V_{DN}
609: first comparator
610: second comparator
801: initial data
802: normalized data
901,902: difference of reference voltages between channels according to presence of touch

1. A capacitive touch sensor comprising:
at least one receiver channel R_{X} which outputs analog data of a voltage for change in capacitance caused by presence or absence of a transmitter channel T_{X} pulse impression and touch;
at least one receiver unit which is connected to the receiver channel R_{X}, receives the analog data of the voltage, and outputs bipolar pulse width modulation signals;
a counter which periodically operates in accordance with reset RST signals; and
at least one flip-flop which outputs, as digital data, the bipolar pulse width modulation signals input from the receiver unit, by using count values received from the counter.

2. The capacitive touch sensor of claim 1, further comprising control logic units receiving and comparing digital data from neighboring flip-flops with each other to output only one digital data based on a most significant bit.

3. The capacitive touch sensor of claim 1, wherein the counter comprises an n-bit down counter determining an n+1 bit being a most significant bit (MSB) according to polarities of the bipolar PWM signals from the receiver unit.

4. The capacitive touch sensor of claim 1, wherein the receiver unit compares analog data of voltages generated from neighboring channels among the receiver channels with each other, and modulates pulse widths of the respective analog data to output bipolar PWM signals.

5. The capacitive touch sensor of claim 1, wherein the receiver unit comprises:
at least one sampling/holding signal impression unit connected to the receiver channels, respectively for impressing a sampling/hold signal to sample the analog data of the voltage;
a charge transfer sensing receiving and comparing the sampled analog data output from neighboring sampling/holding signal impression unit with each other based on a charge amount to output analog data; and
a pulse width modulator receiving outputs of the charge transfer sensing and modulating a pulse signal width of the outputs of the charge transfer sensing to output the bipolar PWM signals.

6. The capacitive touch sensor of claim 5, wherein the charge transfer sensing comprises:
a Gm-amplifier receiving and comparing output signals of the neighboring sampling/holding impression units with each other to generate an output voltage;
a first capacitor connected to an output terminal of the Gm-amplifier to charge/discharge an electric charge; and
an initial voltage impression terminal connected to an output terminal of the Gm-amplifier by on/off of a reset signal RST to impress an initial voltage.

7. The capacitive touch sensor of claim 4, wherein the pulse width modulator comprises:
a first comparator receiving an output voltage of a charge transfer system through a positive input terminal and an up-reference voltage through a negative input terminal to output a positive PWM signal among the bipolar PWM signals; and
a second comparator receiving the output voltage of the charge transfer system through a positive input terminal and a down-reference voltage through a negative input terminal to output a negative PWM signal among the bipolar PWM signals.

8. The capacitive touch sensor of claim 7, wherein based on a reset signal applied to an output voltage terminal, the up-reference voltage is reduced according to lapse of a time, and the down-reference voltage is increased according to the lapse of the time.

9. The capacitive touch sensor of claim 7, wherein the up-reference voltage and the down-reference voltage are a same as each other within one period of the reset signal at least once according to an output of the counter.

10. The capacitive touch sensor of claim 1, wherein a period of the positive PWM signal PWM_POS is determined by a following equation:
$${T}_{PWP} = T - \frac{{C}_{L} ( {V}_{TOP} - {V}_{INT} )}{{G}_{m} ( {V}_{S} [ n + 1 ] - {V}_{S} [ n ] ) - C \frac{{V}_{INT} - {V}_{TOP}}{T}}$$
where, the T is a period of the reset signal, the C_{L} is capacitance of a first capacitor, the V_{TOP} is a maximum value of the up-reference voltage V_{UP}, the V_{INT} is an initial voltage, the Gₘ is mutual conductance, the V_{S} [n+1] and V_{S} [n] are output voltages of neighboring sampling/holding signal impression units; and
a period of the negative PWM signal PWM_NEG is determined by a following equation:
$${T}_{PWN} = T - \frac{{C}_{L} ( {V}_{INT} - {V}_{BOT} )}{{G}_{m} ( {V}_{S} [ n ] - {V}_{S} [ n + 1 ] ) - C \frac{{V}_{BOT} - {V}_{INT}}{T}}$$
where, the T is the period of the reset signal, the C_{L} is the capacitance of the first capacitor, the V_{BOT} is a minimum value of the down-reference voltage V_{DN}, the V_{INT} is the initial voltage, the Gₘ is mutual conductance, the V_{S} [n+1] and V_{S} [n] are the output voltages of the neighboring sampling/holding signal impression units.

11. The capacitive touch sensor of claim 2, wherein the digital data output from the control logic unit are converted by calibration and normalization using a following equation:
$${D}_{NORM ( m - BIT )} = {( \frac{\frac{{2}^{y}}{{2}^{y} - \vert {D}_{IN} \vert} {D}_{IN}}{{2}^{x}} )}_{( ( 2 x > y ) - x ) - BIT} - {( \frac{\frac{{2}^{y}}{{2}^{y} - \vert {D}_{CAL} \vert} {D}_{CAL}}{{2}^{x}} )}_{( ( 2 x \times y ) - x ) - BIT}$$
where, the D_{NORM(m-BIT)} is digital data normalized with an m bit, the D_{CAL} is a value acquiring initial data when there is no touch, and the D_{IN} is data according to the presence or absence of the touch in an actual operation, the m=(2·y)−x, the m, the x, and the y are a predetermined bit.

12. The capacitive touch sensor of claim 11, wherein a sum of converted digital data from a first channel to the n-th channel by the calibration and the normalization is used as final data for determining the presence of the touch, and the sum of the converted digital data satisfies following equations:
$$D ( n ) = {\sum }_{1}^{n} {D}_{NORM} ( n - 1 )$$
$$here {D}_{NORM} ( 0 ) = 0$$
where, the D(n) is data of the n-th channel and the D_{NORM}(n) is normalized data of the n-th channel.
